(19) United States
(12) Patent Application Publication
(10) Pub. No.: US 2024/0106279 A1
(43) Pub. Date: Mar. 28, 2024

(54) CHARGING DEVICE AND CHARGING SYSTEM

(71) Applicant: InnoCare Optoelectronics Corporation, Tainan City (TW)

(72) Inventor: Sung-Pao Cheng, Tainan City (TW)

(73) Assignee: InnoCare Optoelectronics Corporation, Tainan City (TW)

(21) Appl. No.: 18/450,419

(22) Filed: Aug. 16, 2023

(30) Foreign Application Priority Data
Sep. 28, 2022 (TW) 111136698

(51) Int. Cl. H02J 50/40; H02J 50/10; H02J 50/90

(52) U.S. Cl. CPC H02J 50/402; H02J 50/10; H02J 50/90

(57) ABSTRACT

A charging device used to form a charging loop with an electronic device is provided. The charging device includes a base and a first wireless charging terminal. The first wireless charging terminal is disposed in the base, wherein the first wireless charging terminal and the base can move relatively. A charging system is also provided.

### CROSS-REFERENCE TO RELATED APPLICATION

This application claims the priority benefit of Taiwan application serial no. 111136698, filed on Sep. 28, 2022. The entirety of the above-mentioned patent application is hereby incorporated by reference herein and made a part of this specification.

BACKGROUND

### Technical Field

The disclosure relates to a charging device and a charging system, and in particular to a wireless charging device and a wireless charging system.

### Description of Related Art

When an electronic device is being wireles sly charged, a power-sending terminal and a power-receiving terminal need to be precisely aligned to maximize the charging effect. If wireless charging is applied to a mobile device (such as a mobile detector), a shift may occur between the power-sending terminal and the power-receiving terminal when the mobile device is moved and vibration is generated, which may easily lead to discontinuity or breakpoints in wireless charging, prolonging the charging time of the electronic device.

### SUMMARY

The disclosure provides a charging device and a charging system that help improve the charging efficiency and/or the storage convenience.

In an embodiment of the disclosure, a charging device is used to form a charging loop with an electronic device. The charging device includes a base and a first wireless charging terminal. The first wireless charging terminal is disposed in the base. The first wireless charging terminal and the base can move relatively.

In an embodiment of the disclosure, a charging system includes a base, an electronic device, a first wireless charging terminal, and a second wireless charging terminal. The electronic device is disposed adjacent to the base. The first wireless charging terminal is disposed in the base. The second wireless charging terminal is disposed in the electronic device. The first wireless charging terminal and the base can move relatively.

In an embodiment of the disclosure, a charging system includes a base, an electronic device, a first wireless charging terminal, and a second wireless charging terminal. The 10 electronic device is disposed adjacent to the base. The first wireless charging terminal is disposed in the base. The second wireless charging terminal is disposed in the electronic device. The second wireless charging terminal and the electronic device can move relatively.

To make the aforementioned more comprehensible, several embodiments accompanied with drawings are described in detail as follows.

### BRIEF DESCRIPTION OF THE DRAWING

FIG. 1A, FIG. 2A, FIG. 3A, and FIG. 4 are respectively schematic views of a charging device in a charging system before an electronic device is stored according to multiple embodiments of the disclosure.

FIG. 1B is a schematic view of a charging device in a charging system of FIG. lA after an electronic device is stored.

FIG. 1C is a schematic cross-sectional view of a cross-sectional line I-I′ in FIG. 1B.

FIG. 2B is a schematic cross-sectional view of a charging device in a charging system of FIG. 2A after an electronic device is stored.

FIG. 3B is a schematic view illustrating a forced direction of a second wireless charging terminal when an electronic device is stored.

### DESCRIPTION OF THE EMBODIMENTS

Reference will now be made in detail to exemplary embodiments of the disclosure, examples of which are illustrated in the accompanying drawings. Wherever possible, the same reference numerals are used in the drawings and descriptions to refer to the same or similar parts.

Certain terms are used to refer to specific elements throughout the specification and the appended claims of the disclosure. Persons skilled in the art should understand that manufacturers of electronic devices may refer to the same elements with different names. The disclosure does not intend to distinguish elements with the same functions but different names. In the following specification and claims, the terms “including”, “containing”, etc. are open-ended terms, so they should be interpreted to mean “including but not limited to . . . ”.

Directional terms mentioned herein, such as “top”, “bottom”, “front”, “back”, “left”, “right”, etc., refer to directions in the accompanying drawings. Accordingly, the directional 15 terms provided herein serve to describe rather than to limit the disclosure. In the accompanying drawings, each figure illustrates general features of methods, structures, and/or materials applied in particular embodiments. However, these figures should not be construed to define or limit the scope or nature covered by the embodiments. For instance, relative dimensions, thicknesses, and positions of various layers, regions, and/or structures may be reduced or enlarged for clarity.

In the disclosure, when a structure (or layer, element, substrate) is described to be located on/over another structure (or layer, element, substrate), it may mean that the two structures are adjacent and directly connected, or it may mean that the two structures are adjacent but not directly connected. Indirect connection means that there is at least one intermediary structure (or intermediary layer, intermediary element, intermediary substrate, intermediary space) between the two structures. The lower surface of one structure is adjacent to or directly connected to the upper surface of the intermediary structure, and the upper surface of another structure is adjacent to or directly connected to the lower surface of the intermediary structure. The intermediary structure may be composed of a single-layer or multi-layer physical structure or a non-physical structure, which is not limited. In the disclosure, when a certain structure is disposed “on” other structures, it may mean that the certain structure is “directly” on other structures, or that the certain structure is “indirectly” on other structures, that is, at least one structure is also sandwiched between the certain structure and other structures.

The terms “about”, “equal to”, “equivalent to” or “same”, “substantially”, or “approximately” are generally interpreted as being within 20% of a given value or range, or interpreted as being within 10%, 5%, 3%, 2%, 1%, or 0.5% of the given value or range. Furthermore, the phrases “range from a first value to a second value” and “range between the first value and the second value” mean that the range includes the first value, the second value, and other values in between.

Ordinal numbers such as “first” and “second” used in the specification and the claims are used to modify elements, and the terms do not imply or represent that the element(s) have any previous ordinal numbers, nor do they represent the order of a certain element or another element, or the order of a manufacturing method. The use of the ordinal numbers is only used to clearly distinguish between an element with a certain name and another element with the same name. The claims and the specification may not use the same terms. Accordingly, a first component in the specification may be a second component in the claims.

In some embodiments of the disclosure, terms related to joining and connecting, such as “connection”, “interconnect”, etc., unless otherwise defined, may mean that two structures are in direct contact, or may also mean that the two structures are not in direct contact, wherein there are other structures located between these two structures. Also, the terms related to joining and connecting may also include the case where both structures are movable or both structures are fixed. Furthermore, the term “coupling” includes any direct and indirect means of electrical connection. Furthermore, the term “connection” includes a means of signal communication by which two elements or devices can directly or indirectly receive and/or transmit wireless signals.

An electrical connection or coupling described in the disclosure may refer to a direct connection or an indirect connection. In the case of the direct connection, terminal points of elements on two circuits are directly connected or connected to each other by a conductor segment. In the case of indirect connection, there are switches, diodes, capacitors, inductors, resistors, other suitable elements, or a combination of the above elements between the terminal points of the elements on the two circuits, but not limited thereto.

In the disclosure, measurement of thickness, length, and width may be done by applying an optical microscope (OM), and the thickness or the width may be obtained by measuring a cross- sectional image in an electron microscope, but not limited thereto. In addition, any two values or directions used for comparison may have certain errors. Also, the phrases “the given range is from the first value to the second value”, “the given range falls within the range of the first value to the second value”, or “the given range is between the first value and the second value” means that the given range includes the first value, the second value, and other values in between. If a first direction is perpendicular to a second direction, an angle between the first direction and the second direction may be between 80 degrees and 100 degrees; if the first direction is parallel to the second direction, an angle between the first direction and the second direction may be between 0 degrees and 10 degrees.

It should be noted that features of several different embodiments below can be replaced, reorganized, and mixed to complete other embodiments without departing from the spirit of the disclosure. The features between the embodiments can be arbitrarily mixed and matched as long as they do not depart from or conflict with the spirit of the disclosure.

Unless otherwise defined, all terms (including technical and scientific terms) used herein have the same meaning as commonly understood by persons skilled in the art to which this disclosure belongs. It is to be understood that such terms, such as those defined in commonly used dictionaries, should be interpreted as having meanings consistent with the relevant art and the background or context of the disclosure, and should not be interpreted in an idealized or overly formal manner, unless specifically defined in the embodiment of the disclosure.

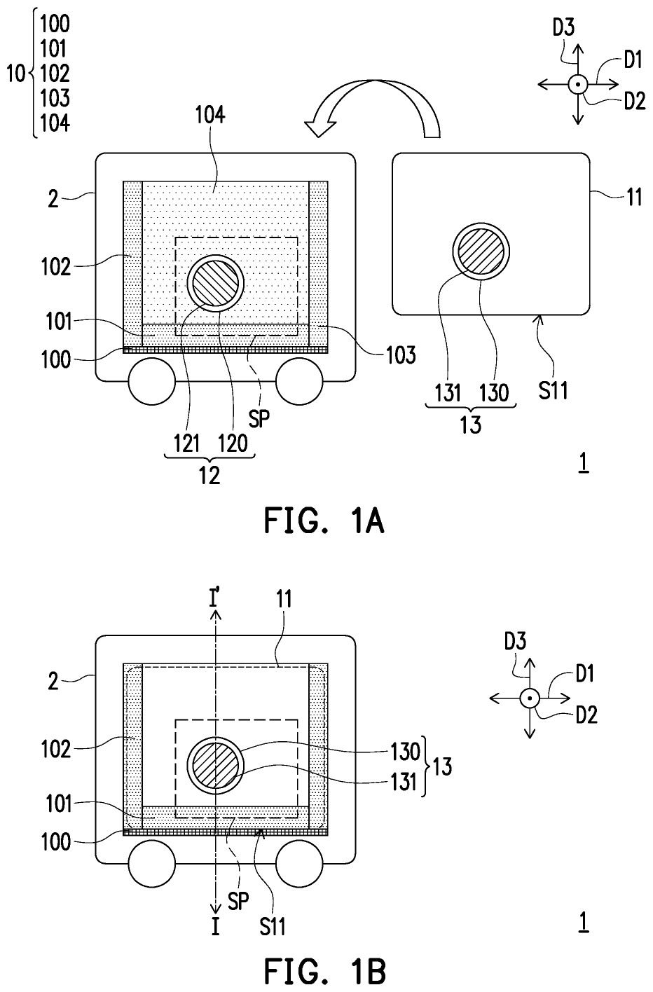

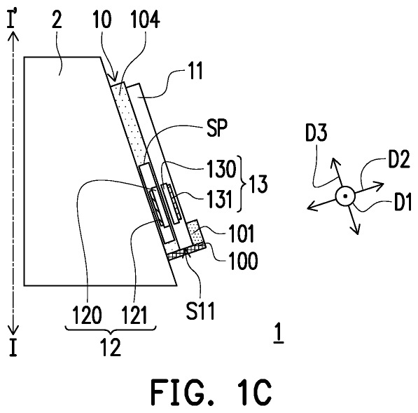

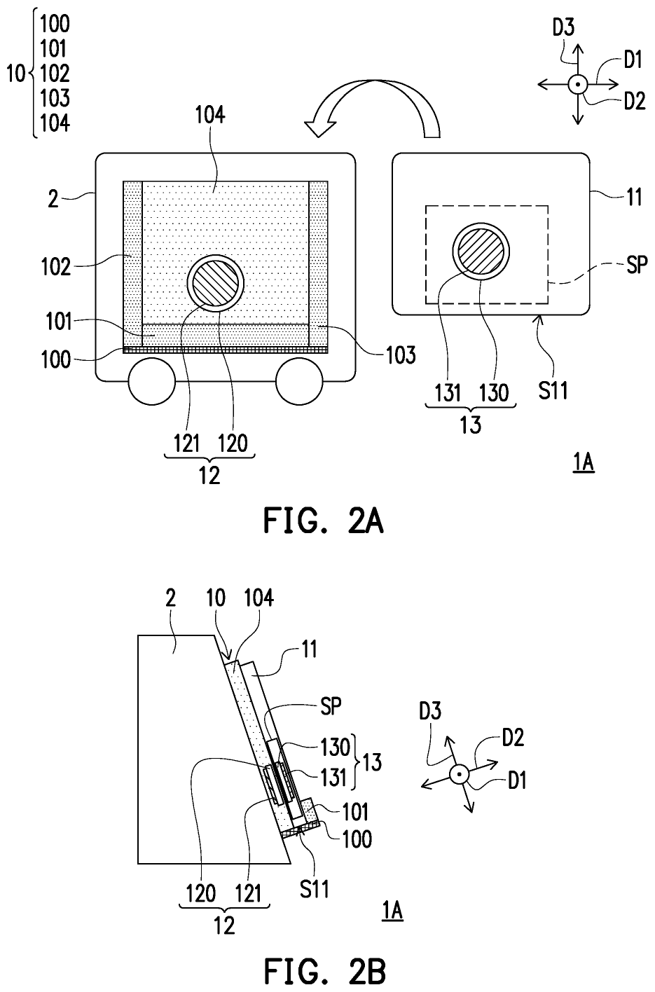

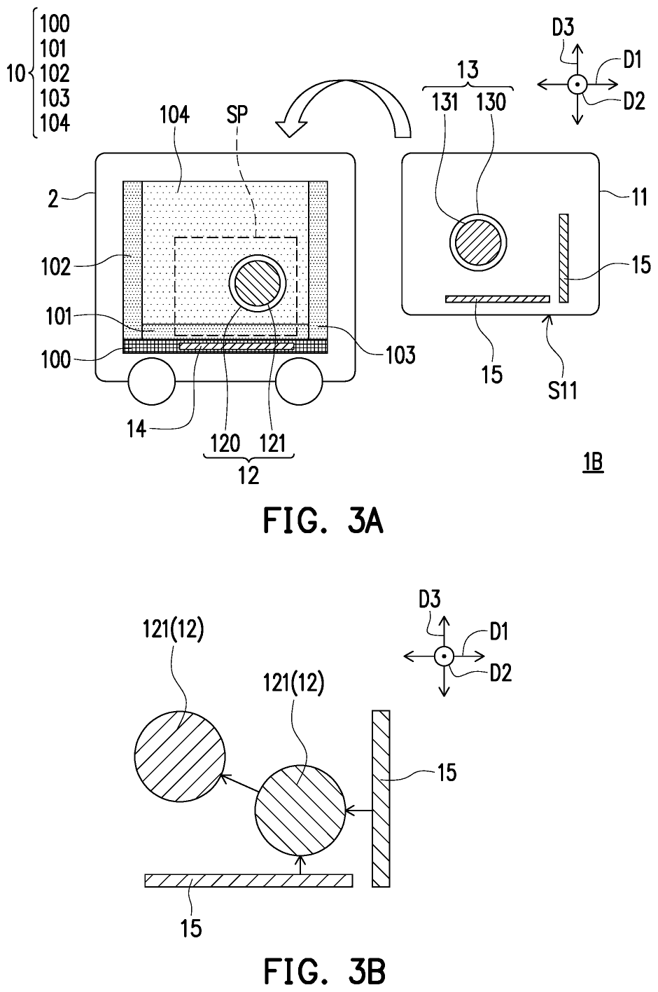

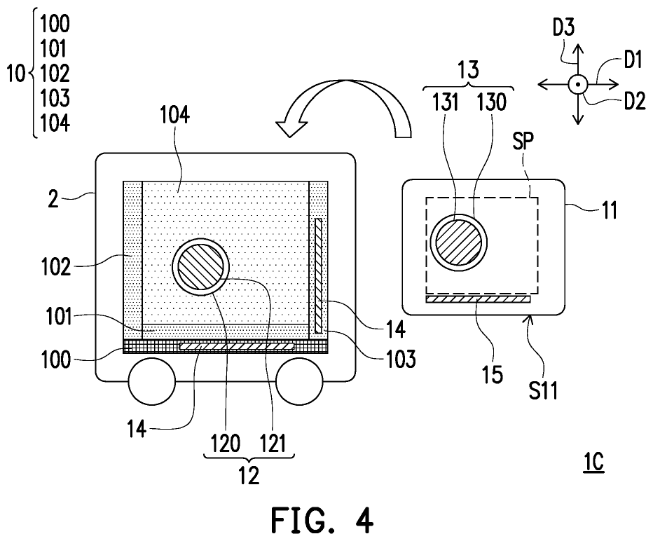

FIG. 1A, FIG. 2, FIG. 3A, and FIG. 4 are respectively schematic views of a charging device in a charging system before an electronic device is stored according to multiple embodiments of the disclosure. FIG. 1B is a schematic view of the charging device in the charging system of FIG. lA after the electronic device is stored. FIG. 1C is a schematic cross- sectional view of a cross-sectional line I-I′ in FIG. 1B. FIG. 2B is a schematic cross-sectional view of the charging device in the charging system of FIG. 2A after the electronic device is stored. FIG. 3B is a schematic view illustrating a forced direction of a second wireless charging terminal when the electronic device is stored.

Referring to FIG. 1A to FIG. 1C, a charging system 1 may include an electronic device 11 and a charging device 2, and the electronic device 11 may be stored in the charging device 2.

The charging device 2 may include a base 10 and a first wireless charging terminal 12, but the disclosure is not limited thereto. The first wireless charging terminal 12 may be disposed in the base 10, so the first wireless charging terminal 12 may not be displayed on the exterior of the base 10. In an embodiment, the base 10 may include a transparent material (e.g., glass or acrylic), and the first wireless charging terminal 12 may be displayed on the exterior of the base 10. The first wireless charging terminal 12 of the charging device 2 and the base 10 can move relatively, but the disclosure is not limited thereto. In other embodiments, the relative positions of the first wireless charging terminal 12 and the base 10 are, for example, fixed. The electronic device 11 may include a second wireless charging terminal 13, the second wireless charging terminal 13 is disposed in the electronic device 11, and the relative positions of the second wireless charging terminal 13 and the electronic device 11 are, for example, fixed, but the disclosure is not limited thereto. In other embodiments, the second wireless charging terminal 13 and the electronic device 11 can move relatively.

In detail, the base 10 of the charging device 2 can be used to load or store the electronic device 11, and the first wireless charging terminal 12 in the base 10 and the second wireless charging terminal 13 in the electronic device 11 can form a charging loop, hence enabling wireless charging. For example, the first wireless charging terminal 12 may be a power-sending terminal, and the second wireless charging terminal 13 may be a power-receiving terminal. Under this configuration, the charging device 2 can wirelessly charge the electronic device 11. Alternatively, the first wireless charging terminal 12 may be the power-receiving terminal, and the second wireless charging terminal 13 may be the power-sending terminal. Under this configuration, the electronic device 11 can wirelessly charge the charging device 2.

In some embodiments, as shown in FIG. 1A, when the electronic device 11 is a mobile detection device, the charging device 2 can be a movable charging device, such as a mobile cart, 15 etc. When the first wireless charging terminal 12 is the power-sending terminal, the charging device 2 can charge an element or a device (e.g., the electronic device 11) stored therein. On the other hand, when the first wireless charging terminal 12 is the power-receiving terminal, the charging device 2 can be used as an accumulator battery, the element or the device (such as the electronic device 11) stored therein can charge the charging device 2, and the power stored in the charging device 2 can be transferred to other elements or devices that need to be charged, such as other elements (not shown) disposed on the charging device 2 (e.g., a mobile cart), through wired or wireless means.

The specific form of the base 10 is not limited. Take FIG. lA for example, the base 10 may include a supporting part 100, a limiting part 101, a limiting part 102, a limiting part 103, and a limiting part 104. The limiting part 101, the limiting part 102, the limiting part 103, and the limiting part 104 are disposed on the supporting part 100 and connected to the supporting part 100. The limiting part 102 and the limiting part 103 are relatively disposed in a direction D1 and can be used to limit the amount of displacement of the element or the device (such as the electronic device 11) stored in the base 10 in the direction Dl. The limiting part 101 and the limiting part 104 are located between the limiting part 102 and the limiting part 103 and are relatively disposed in a direction D2, and the limiting part 101 and the limiting part 104 can be used to limit the amount of displacement of the element or the device (such as the electronic device 11) stored in the base 10 in the direction D2.

For example, the supporting part 100 may include a board, and the limiting part 101, the limiting part 102, the limiting part 103, and the limiting part 104 may include slots, baffle boards, or other suitable limiting/fixing elements. It should be understood that the design parameters (such as the number, shape, size, relative configuration relationship, material, etc. of elements) of the base 10 can be changed according to requirements and are not limited to those shown in FIG. 1A to FIG. 1C. For example, the base 10 may omit at least one of the limiting part 101 and the limiting part 104. Alternatively, the base 10 may omit the limiting part 102 and the limiting part 103. Alternatively, the limiting part 101 may be of equal height with the limiting part 104 in a direction D3. Furthermore, the shape and/or size of the base 10 can be changed as required. In some embodiments, the supporting part 100, the limiting part 101, the limiting part 102, the limiting part 103, and the limiting part 104 may be made of a single material and may be an integrated structure. In other embodiments, the supporting part 100, the limiting part 101, the limiting part 102, the limiting part 103, and the limiting part 104 may be formed of various materials and may be fixed together through mechanical components, adhesives, or other fixing means.

In some embodiments, the base 10 may have a space SP, and the first wireless charging terminal 12 is disposed in the space SP. The space SP is a cavity inside the base 10 for accommodating the first wireless charging terminal 12. The size (e.g., the width in the direction D1, the direction D2, and/or the direction D3) of the space SP can be designed to be larger than the size of the first wireless charging terminal 12 to improve the storage convenience and/or improve the flexibility of the disposed position of the wireless charging terminal.

Although not shown, in other embodiments, a mobile cart can be used as the base 10, and the first wireless charging terminal 12 can be disposed in the mobile cart (i.e., the base 10). When the first wireless charging terminal 12 is the power-sending terminal, the mobile cart (i.e., the base 10) can charge the element or the device (e.g., the electronic device 11) stored therein. On the other hand, when the first wireless charging terminal 12 is the power-receiving terminal, the mobile cart (i.e., the base 10) can be used as the accumulator battery, the element or the device (such as the electronic device 11) stored therein can charge the mobile cart (i.e., the base 10), and the power stored in the mobile cart (i.e., the base 10) can be transmitted to other elements or devices that need to be charged, such as other elements (not shown) disposed on the mobile cart (i.e., the base 10), through wired or wireless means.

There are no restrictions on the type or use of the mobile cart. For example, the mobile cart may be a work cart, a storage cart, a cargo cart, a folding cart, a flat cart, or other movable vehicles. In addition, the mobile cart may also be used to transport medical instruments, electronics, food, goods, or other elements or devices.

There are no restrictions on the type or form of the electronic device 11. For example, the electronic device 11 may be a display device, a backlight device, an antenna device, a detection device, a splicing device, or any device that needs to be charged. In addition, the electronic device 11 may be a bendable or flexible electronic device. The display device may be a non-self- luminous display device or a self-luminous display device. The display device may, for example, include liquid crystal, light emitting diode, fluorescence, phosphor, quantum dot (QD), other suitable display mediums, or a combination of the aforementioned. The antenna device may be a liquid crystal form antenna device or a non-liquid crystal form antenna device. The detection device may be a detection device for sensing capacitance, light (e.g., visible light or X-ray), thermal energy, or ultrasonic wave, but not limited thereto. In some embodiments, the electronic device 11 may include an electronic element. The electronic element may include a passive lement and an active component, such as a capacitor, a resistor, an inductor, a diode, a transistor, etc. The diode may include a light emitting diode or a photodiode. The light emitting diode may, for example, include an organic light emitting diode (OLED), a mini LED, a micro LED, or a quantum dot LED, but not limited thereto. The splicing device may be, for example, a display splicing device, a detection splicing device, or an antenna splicing device, but not limited thereto. It should be noted that, the electronic device 11 can be any arrangement and combination

of the aforementioned, but not limited thereto. In addition, the shape of the electronic device 11 may be a rectangle, a circle, a polygon, a shape with curved edges, or other suitable shapes. The electronic device 11 may have a peripheral system such as a driving system, a control system, a light source system, etc. to support a display device, an antenna device, a wearable device (for example, including augmented reality or virtual reality), an in-vehicle device (for example, including a car windshield), a splicing device, etc.

The first wireless charging terminal 12 and the second wireless charging terminal 13 respectively include a first coil 120 and a second coil 130, and the first coil 120 and the second coil 130 utilize Faraday's law of electromagnetic induction to generate induced current, thereby transferring energy from the power-sending terminal to the power-receiving terminal, hence enabling wireless charging.

In some embodiments, as shown in FIG. 1A and FIG. 1C, the first wireless charging terminal 12 and the second wireless charging terminal 13 may further respectively include a magnetic body 121 (referred to as a second magnetic body in the claims) and a magnetic body 131 (referred to as a fourth magnetic body in the claims), wherein the magnetic body 121 can be disposed on the back side of the first coil 120, and the magnetic body 131 can be disposed on the back side of the second coil 130, so that when the first wireless charging terminal 12 and the second wireless charging terminal 13 are disposed adjacent to each other, the first coil 120 and the second coil 130 are located between the magnetic body 121 and the magnetic body 131 (see FIG. 1C). In FIG. lA and FIG. 1C, in order to clearly illustrate the relative disposed relationship between the first coil 120 and the magnetic body 121, and the relative disposed relationship between the second coil 130 and the magnetic body 131, the magnetic body 121 is shown to be slightly smaller than the first coil 120 and the magnetic body 131 is shown to be slightly smaller than the second coil 130, however, it should be understood that the relative size or the relative disposed relationship 10 of the coil and the corresponding magnetic body can be changed as required and is not limited to those shown in FIG. lA and FIG. 1C.

The magnetic body 121 and the magnetic body 131 may have different magnetism to facilitate the positioning and/or integration of the first wireless charging terminal 12 and the second wireless charging terminal 13. For example, one of the magnetic body 121 and the magnetic body 131 may include an N-type magnet, and the other of the magnetic body 121 and the magnetic body 131 may include an S-type magnet. The second wireless charging terminal 13 and the first wireless charging terminal 12 are attracted to each other based on the principle of magnetism that opposites attract, which reduces the risk of the first wireless charging terminal 12 and the second wireless charging terminal 12 disengaging from each other or having a misalignment when the charging device 2 is moved or vibrated by external force, thereby improving the charging efficiency.

In the case where at least one wireless charging terminal is movable (for example, the position of the first wireless charging terminal 12 relative to the base 10 is variable), if the initial positions of the first wireless charging terminal 12 and the second wireless charging terminal 13 are not aligned when the electronic device 11 is placed in the base 10, then, the wireless charging terminal that is movable (such as the first wireless charging terminal 12) is affected by the magnetic force of the other wireless charging terminal whose position is fixed (for example, the position of the second wireless charging terminal 13 is fixed relative to the electronic device 11) to move towards the wireless charging terminal whose position is fixed, so as to achieve automatic alignment. Based on the above, through the design of the variable (movable) position of the first wireless charging terminal 12, no matter which position the second wireless charging terminal 13 is disposed in the electronic device 11, the first wireless charging terminal 12 and the second wireless charging terminal 13 can be automatically aligned, thereby reducing the risk of the first wireless charging terminal 12 and the second wireless charging terminal 13 disengaging from each other or having a misalignment when the wireless charging between the electronic device 11 and the base 10 is moved or vibrated due to external force, thereby improving the charging efficiency. In other words, through the design of the variable (movable) position of the first wireless charging terminal 12, the disposed position of the second wireless charging terminal 13 relative to the electronic device 11 can be more flexible. In addition, since the position of the first wireless charging terminal 12 is variable (movable), when placing the electronic device 11 in the base 10, the issue of directionality can be ignored, thus the storage convenience is improved. For example, a bottom side Sll of the electronic device 11 can be disposed adjacent to the supporting part 100, disposed adjacent to the limiting part 103 (i.e., the electronic device 11 in FIG. 1B is disposed by being rotated 90 degrees counterclockwise), disposed away from the supporting part 100 (i.e., the electronic device 11 in FIG. 1B is disposed by being rotated 180 degrees counterclockwise), or disposed adjacent to the limiting part 102 (i.e., the electronic device 11 in FIG. 1B is disposed by being rotated 90 degrees clockwise).

Although the foregoing embodiment exemplifies that the position of the second wireless charging terminal 13 is fixed and the first wireless charging terminal 12 can move (the position is variable), the disclosure is not limited thereto. As shown in FIG. 2A and FIG. 2B, in a charging system 1A, the electronic device 11 may have the space SP, and the second wireless charging terminal 13 may be disposed in the space SP, so that the second wireless charging terminal 13 can move (the position is variable) relative to the position of the electronic device 11 and the position of the first wireless charging relative to the base 10 is fixed. In other embodiments not shown, both the base of the charging device and the electronic device may have the space. The first wireless charging terminal may be disposed in the space of the base, and the second wireless charging terminal may be disposed in the space of the electronic device, so the position of the first wireless charging terminal relative to the base can be moved, and the position of the second wireless charging terminal relative to the electronic device can also be moved.

Referring to FIG. 3A and FIG. 3B, the main differences between a charging system 1B and the charging system 1 of FIG. 1A are described as follows. The charging system 1B may further include a magnetic body 14 (i.e., referred to as a first magnetic body in the claims) and a magnetic body 15 (i.e., referred to as a third magnetic body in the claims), and the description of the remaining parts is not repeated.

As shown in FIG. 3A, in an embodiment, the base 10 may have the space SP, and the first wireless charging terminal 12 is disposed in the space SP, and the position of the second wireless charging terminal 13 relative to the electronic device 11 is fixed. Therefore, when the position of the first wireless charging terminal 12 relative to the base 10 is variable, the magnetic body 14 can be disposed in the base 10 and adjacent to at least one side of the space SP. FIG. 3A schematically illustrates the magnetic body 14 disposed on the lower side of the space SP. For example, the magnetic body 14 can be disposed inside or outside the supporting part 100, but not limited thereto. In other embodiments not shown, the charging device 2 may include multiple magnetic bodies 14, and the magnetic bodies 14 may be disposed along different sides of the space SP. The magnetic body 14 and the magnetic body 121 of the first wireless charging terminal 12 may have different magnetism. For example, one of the magnetic body 14 and the magnetic body 121 may include an N-type magnet, and the other may include an S-type magnet. When the charging device 2 moves, the magnetic body 14 reduces the probability and/or the area of the first wireless charging terminal 12 moving in the space SP based on the principle of magnetism that opposites attract.

As shown in FIG. 3A, in an embodiment, the magnetic body 15 may be disposed in the electronic device 11 and adjacent to at least one side of the second wireless charging terminal 13. FIG. 3A schematically illustrates two magnetic bodies 15 disposed on two adjacent sides of the second wireless charging terminal 13, but not limited thereto. In other embodiments not shown, the two magnetic bodies 15 may be disposed on two opposite sides of the second wireless charging terminal 13, but not limited thereto. In other embodiments, the electronic device 11 may include more or less of the magnetic body 15. The magnetic body 15 and the magnetic body 121 of the first wireless charging terminal 12 may have the same magnetism, and the magnetic body 15 and the magnetic body 131 of the second wireless charging terminal 13 and the magnetic body 14 may have different magnetism, so the magnetic body 14 and the magnetic body 131 of the second wireless charging terminal 13 may have the same magnetism. For example, the magnetic body 15 and the magnetic body 121 of the first wireless charging terminal 12 may include N-type magnets, while the magnetic body 131 of the second wireless charging terminal 13 and the magnetic body 14 may include S-type magnets. Alternatively, the magnetic body 15 and the magnetic body 121 of the first wireless charging terminal 12 may include S-type magnets, while the magnetic body 131 of the second wireless charging terminal 13 and the magnetic body 14 may include N-type magnets.

In the case where the position of the second wireless charging terminal 13 is fixed and the first wireless charging terminal 12 can move (the position is variable), when the electronic device 11 is placed in the base 10, the initial positions of the first wireless charging terminal 12 and the second wireless charging terminal 13 may be misaligned. When the first wireless charging terminal 12 includes a magnetic body 121, and the magnetic body 121 and the magnetic body 15 have the same magnetism, the first wireless charging terminal 12 is affected by the repulsive force of the magnetic body 15 to move towards a direction away from the magnetic body 15, and the first wireless charging terminal 12 is affected by the magnetic force of the second wireless charging terminal 13 to move towards the second wireless charging terminal 13 to be attracted together. Using the magnetic body 15 to push the magnetic body 121 to drive the first wireless charging terminal 12 to move, the base 10 can have a larger space SP, which helps to further improve the storage convenience, improve the flexibility of the disposed position of the wireless charging terminal, or helps the storage of the electronic device 11 of different sizes. In addition, since the magnetic body 14 and the magnetic body 15 have different magnetism, based on the principle of magnetism that opposites attract, the magnetic force of the magnetic body 15 and the magnetic body 14 helps the storage of the electronic device 11 in the base 10.

Although the foregoing embodiment exemplifies that the position of the second wireless charging terminal 13 is fixed and the first wireless charging terminal 12 can move (the position is variable), the disclosure is not limited thereto. As shown in FIG. 4, in a charging system 1C, the electronic device 11 may have the space SP, and the second wireless charging terminal 13 may be disposed in the space SP, while the position of the first wireless charging terminal 12 relative to the base 10 is fixed. Therefore, when the position of the second wireless charging terminal 13 relative to the electronic device 11 is variable, the second wireless charging terminal 13 includes the magnetic body 131, and the magnetic body 131 and the magnetic body 14 have the same magnetism. Therefore, the second wireless charging terminal 13 is affected by the repulsive force of the magnetic body 14 to move towards a direction away from the magnetic body 14, and the second wireless charging terminal 13 is affected by the magnetic force of the first wireless charging terminal 12 to move towards the first wireless charging terminal 12 to be attracted together.

To sum up, in the embodiments of the disclosure, at least one wireless charging terminal can move (for example, the first wireless charging terminal and the base can move relatively), which can improve the storage convenience or improve the flexibility of the disposed position of the wireless charging terminal. In some embodiments, the charging efficiency can also be improved through disposing the magnetic body.

The above embodiments are only used to illustrate, not to limit, the technical solution of the disclosure. Although the disclosure has been described in detail with reference to the foregoing embodiments, persons skilled in the art should understand that the technical solutions described in the foregoing embodiments can still be modified, or some or all of the technical features thereof can be equivalently replaced. However, these modifications or substitutions do not cause the nature of the corresponding technical solutions to deviate from the scope of the technical solutions of each embodiment of the disclosure.

Although the embodiments and advantages of the disclosure have been disclosed above, it should be understood that persons skilled in the art can make changes, substitutions, and modifications without departing from the spirit and scope of the disclosure, and the features of the embodiments can be arbitrarily mixed and replaced to form other new embodiments. Also, the protection scope of the disclosure is not limited to the processes, machines, manufacturing, material compositions, devices, methods, and steps in the specific embodiments described in the specification. Persons skilled in the art can understand current or future-developed processes, machines, manufacturing, material compositions, devices, methods, and steps from the content of the disclosure, which can be used in accordance with the disclosure as long as they can perform substantially the same functions or achieve substantially the same results in the embodiments described herein. Accordingly, the protection scope of the disclosure includes the above processes, machines, manufacturing, material compositions, devices, methods, and steps. In addition, each claim constitutes a separate embodiment, and the protection scope of the disclosure also includes combinations of the claims and the embodiments. The protection scope of the disclosure shall be determined by the scope of the appended claims.

What is claimed is:

1. A charging device, used to form a charging loop with an electronic device, the charging device comprising:
a base; and
a first wireless charging terminal, disposed in the base,

wherein the first wireless charging terminal and the base can move relatively.

2. The charging device according to claim 1, wherein the base has a space, and the first wireless charging terminal is disposed in the space.

3. The charging device according to claim 2, further comprising:
a first magnetic body, disposed in the base and adjacent to at least one side of the space.

4. The charging device according to claim 3, wherein the first wireless charging terminal comprises a second magnetic body, wherein the first magnetic body and the second magnetic body have different magnetism.

5. A charging system, comprising:
a base;
an electronic device, disposed adjacent to the base;
a first wireless charging terminal, disposed in the base; and
a second wireless charging terminal, disposed in the electronic device, wherein the first wireless charging terminal and the base can move relatively.

6. The charging system according to claim 5, wherein the base has a space, and the first wireless charging terminal is disposed in the space.

7. The charging system according to claim 6, further comprising:
a first magnetic body, disposed in the base and adjacent to at least one side of the space.

8. The charging system according to claim 7, wherein the first wireless charging terminal comprises a second magnetic body, wherein the first magnetic body and the second magnetic body have different magnetism.

9. The charging system according to claim 8, further comprising:
a third magnetic body, disposed in the electronic device and adjacent to at least one side of the second wireless charging terminal, wherein the third magnetic body and the second magnetic body have the same magnetism.

10. The charging system according to claim 8, wherein the second wireless charging terminal comprises a fourth magnetic body, wherein the fourth magnetic body and the first magnetic body have the same magnetism.

11. The charging system according to claim 5, wherein one of the first wireless charging terminal and the second wireless charging terminal is a power-sending terminal, and other one of the first wireless charging terminal and the second wireless charging terminal is a power-receiving terminal.

12. The charging system according to claim 5, wherein a position of the second wireless charging terminal relative to the electronic device is fixed.

13. A charging system, comprising:
a base;
an electronic device, disposed adjacent to the base;
a first wireless charging terminal, disposed in the base; and
a second wireless charging terminal, disposed in the electronic device, wherein the second wireless charging terminal and the electronic device can move relatively.

14. The charging system according to claim 13, wherein the electronic device has a space, and the second wireless charging terminal is disposed in the space.

15. The charging system according to claim 14, further comprising:
a first magnetic body, disposed in the base and adjacent to at least one side of the first wireless charging terminal.

16. The charging system according to claim 15, wherein the first wireless charging terminal comprises a second magnetic body, wherein the first magnetic body and the second magnetic body have different magnetism.

17. The charging system according to claim 16, further comprising:
a third magnetic body, disposed in the electronic device and adjacent to at least one side of the space, wherein the third magnetic body and the second magnetic body have the same magnetism.

18. The charging system according to claim 17, wherein the second wireless charging terminal comprises a fourth magnetic body, wherein the fourth magnetic body and the first magnetic body have the same magnetism.

19. The charging system according to claim 13, wherein one of the first wireless charging terminal and the second wireless charging terminal is a power-sending terminal, and other one of the first wireless charging terminal and the second wireless charging terminal is a power-receiving terminal.

20. The charging system according to claim 13, wherein a position of the first wireless charging terminal relative to the base is fixed.
